(19) United States
(12) Patent Application Publication
(10) Pub. No.: US 2026/0194421 A1
(43) Pub. Date: Jul. 9, 2026

(54) TRAIN TEST BENCH DATA ACQUISITION SYSTEM AND DATA ACQUISITION METHOD

(71) Applicant: MEISHAN CRRC BRAKE SCIENCE & TECHNOLOGY CO., LTD. I, Sichuan (CN)

(72) Inventors: Yitao LUO, Sichuan (CN); Jiheng WU, Sichuan (CN); Bin WANG, Sichuan (CN); Lei XIE, Sichuan (CN); Wenjun LIU, Sichuan (CN); Bali XIAO, Sichuan (CN); Peng YU, Sichuan (CN); Xingyu ZHONG, Sichuan (CN); Tai CHEN, Sichuan (CN); Jialu REN, Sichuan (CN)

(21) Appl. No.: 18/880,214

(22) PCT Filed: Nov. 23, 2023
(86) PCT No.: PCT/CN2023/133639

§ 371 Date: Dec. 30, 2024

(30) Foreign Application Priority Data
May 29, 2023 (CN) 202310610283.0

(51) Int. Cl. G01M 17/08; G01L 5/28

(52) U.S. Cl. CPC G01M 17/08; G01L 5/28

(57) ABSTRACT

Provided are a data acquisition system of the train test bench, and a data acquisition method therefor. The data acquisition system of the train test bench includes a locomotive, test trucks, an industrial control computer, controllers, acquisition modules, and sensors, wherein the locomotive is connected to a first test truck, and a plurality of test trucks, controllers, acquisition modules, and sensors are provided; the plurality of controllers are all connected to the industrial control computer, and each controller is connected to the plurality of acquisition modules; and the plurality of test trucks are provided with a plurality of acquisition sections, and each acquisition section is provided with the plurality of sensors thereon, wherein the plurality of sensors on each acquisition section are connected to one of the acquisition modules; each sensor corresponds to one acquisition channel; and the sensors are configured to acquire the pressure data of the test trucks.

### CROSS-REFERENCE TO RELATED APPLICATION

The present disclosure claims priority to Chinese patent application No. 2023106102830, filed with the Chinese Patent Office on May 29, 2023, entitled “DATA ACQUISITION SYSTEM OF TRAIN TEST BENCH, AND DATA ACQUISITION METHOD THEREFOR”, the entire contents of which are incorporated herein by reference.

### TECHNICAL FIELD

The present disclosure relates to the technical field of train data acquisition, and specifically to a data acquisition system of a train test bench, and a data acquisition method therefor.

### BACKGROUND ART

With the rapid development of sensor technology, the data acquisition technology is gradually extended to the rail transportation industry.

In order to understand and master the characteristics of the train air brake system, it generally acquires critical parameters of the air brake system by a data acquisition system. The prior data acquisition system cannot expand its capacity when applied to a large-tonnage train test bench, so that the number of channels that can be used to acquire data cannot reach the expectation.

### SUMMARY

The object of the present disclosure includes, for example, providing a data acquisition system of a train test bench, which facilitates the capacity expansion to increase the number of channels that can be used to acquire data.

The object of the present disclosure further includes providing a data acquisition method of a train test bench, which facilitates the capacity expansion to increase the number of channels that can be used to acquire data.

The embodiments of the present disclosure can be realized in the following ways.

The embodiments of the present disclosure provide a data acquisition system of the train test bench, including a locomotive, test trucks, an industrial control computer, controllers, acquisition modules, and sensors, wherein
the locomotive is connected to a first test truck, and a plurality of test trucks, controllers, acquisition modules, and sensors are provided; the plurality of controllers are all connected to the industrial control computer, and each controller is connected to the plurality of acquisition modules; and the plurality of test trucks are provided with a plurality of acquisition sections, and each acquisition section is provided with the plurality of sensors thereon, wherein the plurality of sensors on each acquisition section are connected to one of the acquisition modules; each sensor corresponds to one acquisition channel; and the sensors are configured to acquire pressure data of the test trucks.

Optionally, a plurality of acquisition sections are evenly arranged in the plurality of test trucks at intervals.

Optionally, in a conventional acquisition mode, the plurality of acquisition sections are evenly arranged in the plurality of test trucks at intervals, and the number of acquisition sections is smaller than the number of test trucks.

Optionally, each test truck is provided with one acquisition section.

Optionally, in an all-type acquisition mode, each test truck is provided with one acquisition section, and the number of the acquisition sections is equal to the number of the test trucks.

Optionally, the plurality of test trucks are arranged in a serpentine arrangement, and the plurality of controllers are sequentially arranged in an arrangement path of the plurality of test trucks.

Optionally, the data acquisition system of the train test bench further includes a switch, wherein the plurality of controllers are all connected to the switch, and the switch is connected to the industrial control computer.

Optionally, the switch is further connected to the plurality of acquisition modules.

Optionally, each acquisition module connected to the switch is connected to the plurality of sensors.

Optionally, each test truck is provided with a train tube, an auxiliary air cylinder, a brake cylinder, an accelerated relief air cylinder, a local pressure reduction chamber, and an emergency chamber; and the pressure data of the test trucks includes a train tube pressure, an auxiliary air cylinder pressure, a brake cylinder pressure, an accelerated relief air cylinder pressure, a local pressure reduction chamber pressure, and an emergency chamber pressure.

Optionally, train tubes of the adjacent test trucks are connected, wherein the locomotive is provided with a wind source system, and the wind source system is connected to the train tube of the first test truck.

Optionally, acquisition delay of each acquisition channel is no more than 10 ms.

Optionally, the plurality of controllers are connected in parallel via a network cable, and one of the controllers is connected to the industrial control computer for data transmission via the network cable.

The embodiments of the present disclosure further provide a data acquisition method applied to the above data acquisition system of the train test bench, wherein the data acquisition method includes:
acquiring the pressure data of a single test truck by the plurality of sensors on each acquisition section and transmitting the pressure data to the corresponding acquisition module;
transmitting the pressure data of the plurality of test trucks to the corresponding controller by the plurality of acquisition modules;
converting the pressure data of the test trucks in a digital-to-analog method by each controller, and sending it to the industrial control computer in the form of electrical signals; and
recognizing and converting the electrical signals by the industrial control computer, and presenting in the form of a curve.

Optionally, the step of converting the pressure data of the test trucks in a digital-to-analog method by each controller and sending it to the industrial control computer in the form of electrical signals includes:
converting the pressure data of the test trucks in a digital-to-analog method by each controller and sending it to the industrial control computer in the form of electrical signals through the switch.

The data acquisition system of the train test bench and the data acquisition method provided by the embodiments of the present disclosure include the following beneficial effects. For example, the plurality of sensors on each acquisition section acquire the pressure data of the single test truck and transmit the pressure data to the corresponding acquisition module; the plurality of acquisition modules transmit the pressure data of the plurality of test trucks to the corresponding controller; each controller converts the pressure data of the test trucks in the digital-to-analog method and summarizes it to the industrial control computer in the form of electrical signals; and finally the industrial control computer recognizes and converts the electrical signals by software and presents in the form of a curve. In the process, if the number of acquisition sections needs to be increased, that is, the number of acquisition channels needs to be increased, it only needs to increase the number of controllers, acquisition modules, and sensors to expand the capacity.

### BRIEF DESCRIPTION OF DRAWINGS

In order to more clearly illustrate the technical solutions in the embodiments of the present disclosure, the following will briefly introduce the drawings to be used in the embodiments. It is to be understood that the following drawings illustrate only certain embodiments of the present disclosure, and therefore should not be regarded as a limitation of the scope. For persons of ordinary skill in the field, other relevant drawings can be obtained based on these drawings without inventive efforts.

FIG. 1 shows a schematic diagram of a data acquisition system in the embodiments of the present disclosure;

FIG. 2 shows a schematic diagram of an arrangement of test trucks in the embodiment of the present disclosure;

FIG. 3 shows a schematic diagram of a connection relationship between an acquisition module and sensors in the embodiments of the present disclosure;

FIG. 4 shows a schematic diagram of a connection relationship between a wind source system on a locomotive and a train tube of a first test truck in the embodiments of the present disclosure;

FIG. 5 shows a schematic diagram of a connection relationship among a test truck, a train tube, an auxiliary air cylinder, a brake cylinder, an accelerated relief air cylinder, a local pressure reduction chamber, and an emergency chamber provided by the embodiments of the present disclosure; and

FIG. 6 shows a schematic flow diagram of a data acquisition method provided by the embodiments of the present disclosure.

Reference numbers: 100—locomotive; 110—wind source system; 200—test truck; 210—train tube; 220—auxiliary air cylinder; 230—brake cylinder; 240—accelerated relief air cylinder; 250—local pressure reduction chamber; 260—emergency chamber; 300—industrial control computer; 400—switch; 500—controller; 600—acquisition module; and 700—sensor.

### DETAILED DESCRIPTION OF EMBODIMENTS

In order to make the objectives, technical solutions, and advantages of the embodiments of the present disclosure clearer, the technical solutions in the embodiments of the present disclosure will be clearly and completely described in conjunction with the drawings in the embodiments of the present disclosure. It is clear that the embodiments described are partial embodiments of the present disclosure, but not all of the embodiments. The components in the embodiments of the present disclosure generally described and shown in the drawings herein may be arranged and designed in multiple different configurations.

Therefore, the following detailed description of embodiments of the present disclosure provided in the drawings is not intended to limit the scope of the present disclosure for which protection is claimed, but rather only represents selected embodiments of the present disclosure. Based on the embodiments of the present disclosure, all other embodiments obtained by a person of ordinary skill in the art without inventive efforts, shall fall within the scope of protection of the present disclosure.

It should be noted that similar symbols and letters denote similar items in the following drawings, so that once an item is defined in a drawing, no further definition or explanation is required in the subsequent drawings.

In the description of the present disclosure, it should be noted that the orientation or position relationship indicated by the terms “center”, “up”, “down”, “left”, “right”, “vertical”, “horizontal”, “inside”, “outside”, etc., is the orientation or position relationship based on the drawings, or is the orientation or position relationship of the product of the present disclosure customarily placed in use. This is only to facilitate the description of the present disclosure and simplify the description, and is not to indicate or imply that the device or element referred to must have a particular orientation, or be constructed and operated with a particular orientation. Therefore, it cannot to be understood as a limitation of the present disclosure.

Additionally, the terms “first”, “second”, “third”, etc., are used only to differentiate the description, and are not to be understood as indicating or implying relative importance.

Additionally, the terms “horizontal”, “vertical”, “overhanging”, etc., do not mean that the component must be absolutely horizontal or overhanging, but can be slightly inclined. For example, “horizontal” only refers that it is more horizontal than “vertical”, not indicating that the structure must be absolutely horizontal, but that it may be slightly inclined.

In the description of the present disclosure, it should also be noted that unless other expressly specifications and limitations, the terms “arrange”, “mount”, “connect”, and “link” are to be understood in a broad sense. For example, it may be a fixed connection, a detachable connection, or an integral connection; it can be a mechanical connection or an electrical connection; and it can be a direct connection, an indirect connection through an intermediate medium, or a communication inside two elements. For a person of ordinary skill in the art, the specific meaning of the above terms in the present disclosure can be understood according to specific situations.

It is to be noted that various features in the embodiments of the present disclosure can be combined with each other without conflict.

The inventors of the present disclosure found that the existing data acquisition system cannot expand its capacity when applied to a large-tonnage train test bench, so that the number of channels that can be used to acquire data cannot reach the expectation. The embodiments of the present disclosure provide a data acquisition system of the train test bench for at least addressing this technical problem.

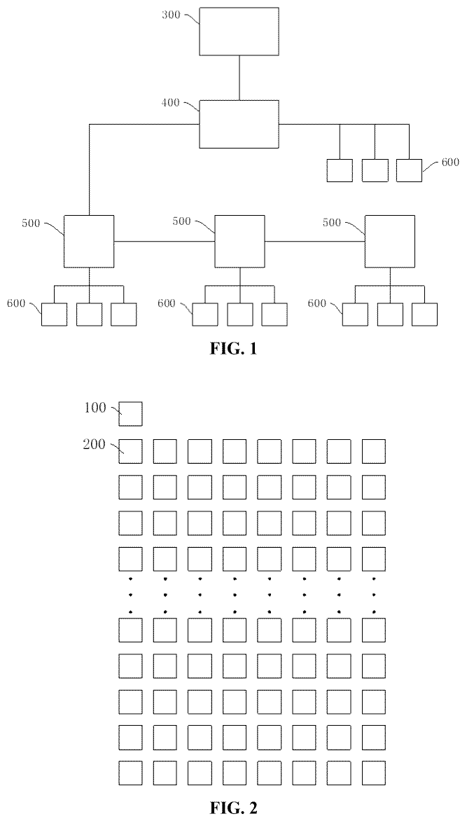

Referring to FIG. 1-FIG. 3, the data acquisition system of the train test bench provided by the embodiments of the present disclosure includes a locomotive 100, test trucks 200, an industrial control computer 300, controllers 500, acquisition modules 600, and sensors 700, wherein the locomotive 100 is connected to a first test truck 200, and a plurality of test trucks 200, controllers 500, acquisition modules 600, and sensors 700 are provided; the plurality of controllers 500 are all connected to the industrial control computer 300, and each controller 500 is connected to the plurality of acquisition modules 600; and the plurality of test trucks 200 are provided with a plurality of acquisition sections, and each acquisition section is provided with the plurality of sensors 700 thereon, wherein the plurality of sensors 700 on each acquisition section is connected to one of the acquisition modules 600; each sensor 700 corresponds to one acquisition channel; and the sensors 700 are configured to acquire pressure data of the test trucks 200.

It is to be noted that the plurality of test trucks 200 are sequentially connected to form a train, and the locomotive 100 is connected to a head part of the train, that is, it is connected to the first test truck 200. The plurality of controllers 500 are connected in parallel via a network cable, and one of the controllers 500 is connected to the industrial control computer 300 for data transmission via the network cable. The plurality of acquisition sections are sequentially arranged on the arrangement path of the plurality of test trucks 200, and each acquisition section corresponds to one test truck 200. The sensors 700 are connected to the reserved interfaces of the train test bench frame, wherein the plurality of sensors 700 on each acquisition section acquire the pressure data of the corresponding test truck 200, and the acquired pressure data is transmitted to the corresponding acquisition module 600 by a shielded cable with the Hirschmann joint. The data acquisition software and recognition software are installed in the industrial control computer 300, wherein the industrial control computer 300 recognizes and converts the electrical signals by software and presents them in the form of a curve on the display, which is easy for the technicians to analyze the test characteristics. Additionally, the data acquisition system is associated and communicated with the simulation software, and PLC software, etc. For example, a data transmission channel is provided between the data acquisition software and the simulation software. When the pressure data is adopted by the acquisition software, it can not only be used for data analysis, but also can be transmitted to the simulation software for dynamics analysis. The pressure reduction command is input into the simulation software; the data acquisition software monitors the amount of pressure reduction of the train test bench; and the PLC software controls a solenoid valve of the operation station of the locomotive 100 to exhaust gas, thus realizing precise pressure reduction with high precision.

The plurality of sensors 700 on each acquisition section acquire the pressure data of the corresponding single test truck 200 and transmit the pressure data to the corresponding acquisition module 600; the plurality of acquisition modules 600 transmit the pressure data of the plurality of test trucks 200 to the corresponding controller 500; each controller 500 converts the pressure data of the test trucks 200 in the digital-to-analog method and summarizes it to the industrial control computer 300 in the form of electrical signals; and finally the industrial control computer 300 recognizes and converts the electrical signals by software and presents them in the form of the curve on the display. In this process, if an increase in the number of acquisition channels is required, it is only necessary to add additional controllers 500, acquisition modules 600, and sensors 700 for capacity expansion, wherein the additional controllers 500 and the original controllers 500 are connected in parallel by network cables. Since the additional controllers 500 are connected to a plurality of new acquisition modules 600, and the new acquisition modules 600 are connected to a plurality of new sensors 700, a large number of sensors 700 can be provided. Accordingly, the number of acquisition channels increases. Additionally, the pressure data is transmitted in a wired method, which has a strong anti-interference capability. The controller 500 and the industrial control computer 300 are connected by the network cable, which has a high data transmission efficiency, a small packet loss rate, and is stable and reliable. The industrial control computer 300 can dump data into formats such as TDMS, JEPG, XLSX, DOCX, TXT, etc., so as to realize the diversity of the data storage methods.

Additionally, the hardware adopted by the data acquisition system includes an NI controller 500 based, and the acquisition module 600, etc., and other hardware models can also be selected without affecting the function. The acquisition software is developed by using Labview, and can also be developed by using C language and so on. The data acquisition system adopts distributed acquisition, wherein the sensor 700 is connected to the controller 500 by using the shielded cable. The controller 500 is connected to the industrial control computer 300 by the network cable, or it can adopt a wireless transmission method.

Referring to FIG. 4, in an optional embodiment, the train tubes of the adjacent test trucks 200 are connected, wherein the locomotive 100 is provided with a wind source system 110, and the wind source system 110 is connected to the train tube 210 of the first test truck 200.

It should be noted that the wind source system 110 is configured to ventilate the train tube 210 of the test truck 200, so as to realize the braking, relief, and pressure preservation for the train. The braking of the train is realized through that the train tube 210 and the auxiliary air cylinder 220 reduce the pressure and the brake cylinder 230 increases the pressure. The pressure preservation of the train is realized by balancing the pressure between the train tube 210 and the auxiliary air cylinder 220 and by cutting off the access to the brake cylinder 230. The relief of the train is realized through that the train tube 210 and the auxiliary air cylinder 220 increase the pressure and the brake cylinder 230 reduces the pressure, during which the accelerated relief air cylinder 240 plays an increasing-pressure role for the train tube 210. The emergency braking is realized by the rapid pressure reduction of the train tube 210 and the emergency chamber 260. Each test truck 200 controls the connection and disconnection of the channels between its tubes through the cooperation and actions of the slide valve, the shut-off valve, and the slide valve sleeve.

The functions of braking, relief, pressure preservation in the train brake system are achieved by switching the matching and pressure relationships between critical tubes. Therefore, the pressure of the train tube 210, the pressure of the auxiliary air cylinder 220, the pressure of the brake cylinder 230, the pressure of the accelerated relief air cylinder 240, the pressure of the local pressure reduction chamber 250, and the pressure of the emergency chamber 260 are selected as critical monitoring points. During the train testing, the sensors 700 perform the synchronous acquisition in real-time and for the pressure data at the critical pressure monitoring points, so as to satisfy the testing requirements of each working condition for the train brake system. Through analyzing the changes of the pressure data at each critical pressure monitoring point and their interrelationships, the function, the state, and the failure condition of the train brake system can be evaluated.

The wind source system 110 is provided by the locomotive 100, and the locomotive 100 prioritizes supplying wind for the adjacent test truck 200. Therefore, the farther the test truck 200 is away from the locomotive 100, the longer the response duration of supplying wind is, and thus the brake system condition of the test truck 200 at each position has a certain difference. In order to meet the requirements of special tests, such as the single-train test and adjacent-train test, the data acquisition system is designed in two modes: a conventional acquisition and an all-type acquisition.

In an optional embodiment, the plurality of acquisition sections are evenly arranged in the plurality of test trucks 200 at intervals.

It is noted that when the plurality of acquisition sections are evenly arranged in the plurality of test trucks 200 at intervals, the data acquisition system is set to be the conventional acquisition mode. Under the conventional acquisition mode, the number of acquisition sections is less than the number of test trucks 200.

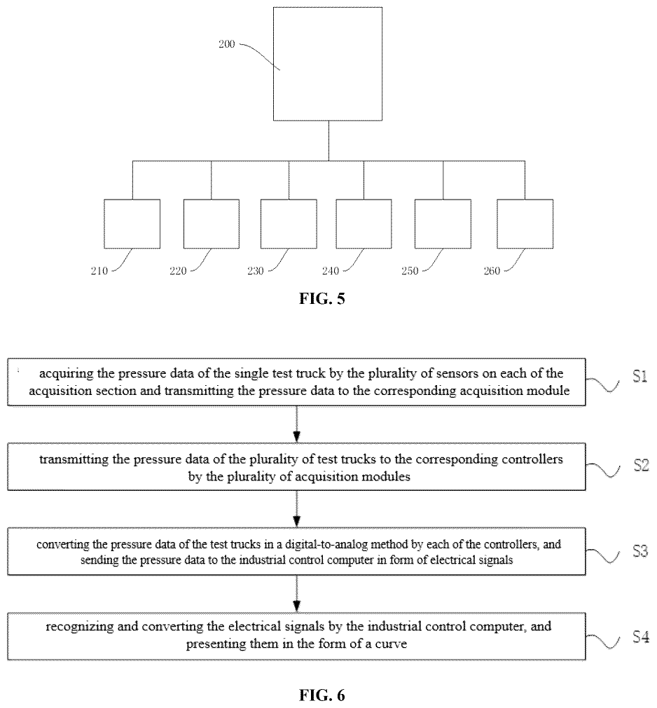

Referring to FIG. 5, each test truck 200 is provided with a train tube 210, an auxiliary air cylinder 220, a brake cylinder 230, an accelerated relief air cylinder 240, a local pressure reduction chamber 250, and an emergency chamber 260. The pressure data of the test trucks 200 includes a pressure of the train tube 210, a pressure of the auxiliary air cylinder 220, a pressure of the brake cylinder 230, a pressure of the accelerated relief air cylinder 240, a pressure of the local pressure reduction chamber 250, and a pressure of the emergency chamber 260.

For example, for a 40,000-ton train test bench, under the conventional acquisition mode, the head train, tail train, and every five cars of each 10,000-ton train are provided with one acquisition section, and each acquisition section is provided with five sensors 700, which acquire the pressure of the train tube 210, the pressure of the auxiliary air cylinder 220, the upstream pressure of the brake cylinder 230, the downstream pressure of the brake cylinder 230, and the pressure of the accelerated relief air cylinder 240; the test truck 200 corresponding to the non-acquisition section is provided with one sensor 700 to acquire the pressure of the brake cylinder 230; and the total number of acquisition channels is about 800, and the 800 acquisition channels can meet the requirements of daily tests.

It is to be understood that the number and positions of the acquisition sections, the number of sensors 700 at each acquisition section, and the type of pressure acquired can be determined by the actual working conditions, for example, the head train, the tail train, and every four trains are provided with one acquisition section, at which time the total number of acquisition channels changes accordingly. The sensor 700 can also acquire the pressure of the local pressure reduction chamber 250 and the pressure of the emergency chamber 260.

In an optional embodiment, each test truck 200 is provided with one acquisition section.

It is noted that when each test truck 200 is provided with one acquisition section, the data acquisition system is set to be the all-type acquisition mode. Under the all-type acquisition mode, the number of acquisition sections is equal to the number of test trucks 200.

For example, each acquisition section is provided with five sensors 700, which acquire the pressure of the train tube 210, the pressure of the auxiliary air cylinder 220, the upstream pressure of the brake cylinder 230, the downstream pressure of the brake cylinder 230, and the pressure of the accelerated relief air cylinder 240. The total number of acquisition channels is more than two thousand, wherein the more than two thousand acquisition channels can cover all test trucks 200. The capacity expansion can be achieved by increasing the number of controllers 500, acquisition modules 600, and sensors 700.

In an optional embodiment, the plurality of test trucks 200 are arranged in a serpentine arrangement, and the plurality of controllers 500 are sequentially arranged in an arrangement path of the plurality of test trucks 200.

It is noted that each controller 500 is correspondingly connected to the plurality of acquisition modules 600; the plurality of sensors 700, connected to each acquisition module 600, acquire the pressure data of the test truck 200 at a corresponding position; and the plurality of controllers 500 are distributed on the arrangement path of the test trucks 200.

For example, a 40,000-ton train test bench includes 432 test trucks 200, wherein the 432 test trucks 200 are arranged in eight columns in the serpentine arrangement; the number of test trucks 200 in each column is 54; the number of controllers 500 is 16. For every ten-thousand-ton train test bench, i.e., on one side of two test trucks 200, two controllers 500 are arranged to realize the full coverage for the acquisition section.

The controllers 500 are arranged in a distribution manner, thereby reducing the length of the cable, so as to solve problems such as complicated wiring conditions, which facilitates maintenance; and each controller 500 is independent to each other, so that the failure of a single controller 500 does not affect the normal operation of the entire data acquisition system.

In an optional embodiment, the data acquisition system of the train test bench further includes a switch 400, wherein the plurality of controllers 500 are all connected to the switch 400, and the switch 400 is connected to the industrial control computer 300.

It is noted that the switch 400 can play a role of data summary, which packages the signals transmitted by the plurality of controllers 500 and send them to the industrial control computer 300.

In an optional implementation, the switch 400 is further connected to the plurality of acquisition modules 600.

It is noted that each acquisition module 600, connected to the switch 400, is also connected to the plurality of sensors 700. Through connecting the plurality of acquisition modules 600 to the switch 400, it can further expand the capacity of the data acquisition system and increase the number of acquisition channels.

Additionally, the acquisition delay of each acquisition channel is no more than 10 ms.

It should be noted that at present, the average length of railroad trucks is about 13.5 m due to different types of the railroad trucks. If the train adopts the air brake system, with a propagation speed of the air brake system being calculated at 330 m/s, the propagation distance is 3.3 m when the acquisition delay of each acquisition channel is set to 10 m. If the train adopts an electric air brake system, with the propagation speed of the electric air brake system being calculated at 1000 m/s, the propagation distance is 10 m when the acquisition delay of each acquisition channel is set to 10 ms.

Since the braking and relief commands of the train brake system are transmitted from the locomotive 100 to the first train and then to the subsequent trains, and since the length of a single train is more than 10 m, the above data acquisition system can control the acquisition delay to within 10 ms. Therefore, the error caused by the acquisition delay within 10 ms will exceed the length of a train, and there will be no situation where the acquisition of one train is followed by that of the previous train, and therefore it will not affect the experimental analysis of the train brake system Referring to FIG. 6, the embodiment of the present disclosure further provides a data acquisition method applied to the above data acquisition system of the train test bench, wherein the data acquisition method includes the following steps S1~S4.

Step S1: acquiring the pressure data of the single test truck 200 by the plurality of sensors 700 on each acquisition section and transmitting the pressure data to the corresponding acquisition module 600.

It is noted that the single acquisition module 600 acquires the pressure data of the corresponding test truck 200 on the single acquisition section, and the single acquisition module 600 acquires the corresponding pressure data by the plurality of sensors 700 connected to itself.

Step S2: transmitting the pressure data of the plurality of test trucks 200 to the corresponding controller 500 by the plurality of acquisition modules 600.

It should be noted that after the corresponding pressure data is acquired, each acquisition module 600 transmits it to the controller 500 connected with itself.

Step S3: converting the pressure data of the test trucks 200 in a digital-to-analog method by each controller 500, and sending it to the industrial control computer 300 in the form of electrical signals.

It should be noted that after each controller 500 converts the pressure data, acquired by the plurality of acquisition modules 600 connected to itself, in the digital-to-analog method, the data is sent to the industrial control computer 300 in the form of the electrical signals after summarized through the switch 400.

Step S4, recognizing and converting the electrical signals by the industrial control computer 300, and presenting them in the form of the curve.

In this step, the industrial control computer 300 recognizes and converts the electrical signals by software, and presents them in the form of the curve on the display, which is easy for the technicians to analyze the test characteristics. The industrial control computer 300 is taken as the summary master computer, which ensures the time consistency of the acquired pressure data at each monitoring point when synchronously authorizing the data acquisition software, so as to realize the real-time acquisition of the pressure data for the train test bench.

In summary, the embodiments of the present disclosure provide a data acquisition system of the train test bench, and a data acquisition method therefor, wherein the data acquisition system can realize the data acquisition and analysis functions for the train test bench. The pressure curves at different acquisition points can be displayed synchronously due to the clock synchronization of the software, so as to meet the data acquisition function of the train-level test. Through comparing and analyzing the interrelationships of each critical parameter under different operations and at the same time, each characteristic of the air brake system can be analyzed in depth. The hardware facilities are arranged in distribution arrangement and network cable cascade, which can reduce the cables to simplify the wiring and facilitate maintenance. Moreover, the failure of the single controller 500 module does not affect the use of the entire system.

In some embodiments,
referring to FIG. 1, the data acquisition system of the train test bench shown in FIG. 1 includes the locomotive 100, the test trucks 200, the industrial control computer 300, the switch 400, the controllers 500, and the acquisition modules 600, wherein the plurality of controllers 500 are all connected to the switch 400; the switch 400 is connected to the industrial control computer 300; each controller 500 is connected to plurality of acquisition modules 600; and the switch 400 is further connected to the plurality of acquisition modules 600.

Referring to FIG. 2, in the arrangement method of the test trucks shown in FIG. 2, the plurality of test trucks 200 are arranged in the serpentine arrangement, and the plurality of controllers 500 are sequentially arranged in the arrangement path of the plurality of test trucks 200.

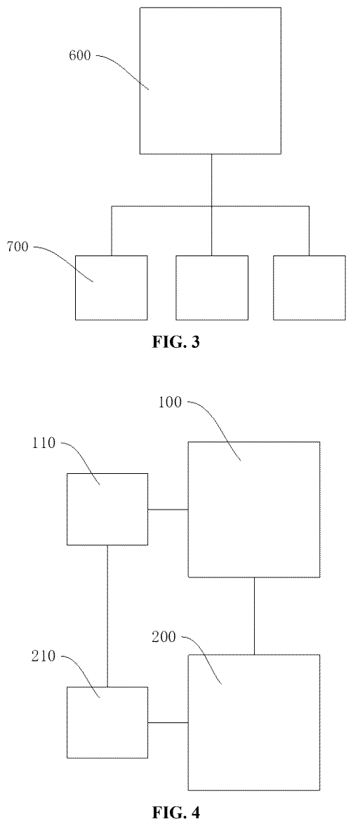

Referring to FIG. 3, the single acquisition module 200 shown in FIG. 3 is connected to the plurality of sensors 700.

Referring to FIG. 4, the locomotive 100 shown in FIG. 4 is provided with the wind source system 110, and the wind source system 110 is connected to the train tube 210 of the first test truck.

Referring to FIG. 5, the test truck 200 shown in FIG. 5 is provided with the train tube 210, the auxiliary air cylinder 220, the brake cylinder 230, the accelerated relief air cylinder 240, the local pressure reduction chamber 250, and the emergency chamber 260. Referring to FIG. 6, the data acquisition method shown in FIG. 6 includes: step S1, acquiring the pressure data of the single test truck 200 by the plurality of sensors 700 on each acquisition section and transmitting the pressure data to the corresponding acquisition module 600; step S2, transmitting the pressure data of the plurality of test trucks 200 to the corresponding controller 500 by the plurality of acquisition modules 600; step S3, converting the pressure data of the test trucks 200 in a digital-to-analog method by each controller 500, and sending it to the industrial control computer 300 in form of electrical signals; and step S4, recognizing and converting the electrical signals by the industrial control computer 300, and presenting them in the form of the curve.

The foregoing are only the embodiments of the present disclosure, but the scope of protection of the present disclosure is not limited thereto. Any modifications or substitutions that could be readily conceived by a person skilled in the art within the technical scope disclosed in the present disclosure shall be covered within the protection scope of the present disclosure. Therefore, the scope of protection of the present disclosure should be governed by the scope of protection of claims.

### INDUSTRIAL APPLICABILITY

In summary, the present disclosure provides a data acquisition system of the train test bench, and a data acquisition method therefor. The sensors acquire the pressure data of the single test truck and transmit the pressure data to the corresponding acquisition module; the acquisition module transmits the pressure data of the test truck to the controller; the controller converts the pressure data of the test trucks in the digital-to-analog method and summarizes it to the industrial control computer in the form of electrical signals; and finally the industrial control computer recognizes and converts the electrical signals by software and presents them in the form of the curve. In the process, if the number of acquisition sections needs to be increased, it only needs to increase the number of controllers, acquisition modules, and sensors to expand the capacity.

1. A data acquisition system of a train test bench, comprising:
a locomotive,
test trucks,
an industrial control computer,
controllers,
acquisition modules, and
sensors,
wherein
the locomotive is connected to a first test truck, and a plurality of test trucks, controllers, acquisition modules, and sensors are provided;
the plurality of controllers is connected to the industrial control computer, and each of the controllers is connected to the plurality of acquisition modules;
the plurality of test trucks is provided with a plurality of acquisition sections, and each of the acquisition sections is provided with the plurality of sensors thereon;
the plurality of sensors on each of the acquisition sections is connected to one of the acquisition modules; each of the sensors corresponds to one acquisition channel; and
the sensors are configured to acquire pressure data of the test trucks.

2. The data acquisition system of the train test bench according to claim 1, wherein the plurality of acquisition sections is evenly arranged in the plurality of test trucks at intervals.

3. The data acquisition system of the train test bench according to claim 2, wherein in a conventional acquisition mode, the plurality of acquisition sections is evenly arranged in the plurality of test trucks at intervals, and a number of the acquisition sections is smaller than a number of the test trucks.

4. The data acquisition system of the train test bench according to claim 1, wherein each of the test trucks is provided with one of the acquisition sections.

5. The data acquisition system of the train test bench according to claim 4, wherein in an all-type acquisition mode, each of the test trucks is provided with one of the acquisition sections, and the number of the acquisition sections is equal to the number of the test trucks.

6. The data acquisition system of the train test bench according to claim 1, wherein the plurality of test trucks is arranged in a serpentine arrangement, and the plurality of controllers is sequentially arranged in an arrangement path of the plurality of test trucks.

7. The data acquisition system of the train test bench according to claim 1, wherein the data acquisition system of the train test bench further comprises a switch, wherein the plurality of controllers is all connected to the switch, and the switch is connected to the industrial control computer.

8. The data acquisition system of the train test bench according to claim 7, wherein the switch is further connected to the plurality of acquisition modules.

9. The data acquisition system of the train test bench according to claim 8, wherein each of the acquisition modules connected to the switch is connected to the plurality of sensors.

10. The data acquisition system of the train test bench according to claim 1, wherein each of the test trucks is provided with a train tube, an auxiliary air cylinder, a brake cylinder, an accelerated relief air cylinder, a local pressure reduction chamber, and an emergency chamber; and the pressure data of the test trucks comprises a train tube pressure, an auxiliary air cylinder pressure, a brake cylinder pressure, an accelerated relief air cylinder pressure, a local pressure reduction chamber pressure, and an emergency chamber pressure.

11. The data acquisition system of the train test bench according to claim 10, wherein train tubes of the adjacent test trucks are connected, the locomotive is provided with a wind source system, and the wind source system is connected to the train tube of the first test truck.

12. The data acquisition system of the train test bench according to claim 1, wherein acquisition delay of each acquisition channel is no more than 10 ms.

13. The data acquisition system of the train test bench according to claim 1 wherein the plurality of controllers is connected in parallel via a network cable, and one of the controllers is connected to the industrial control computer for data transmission via the network cable.

14. A data acquisition method, applied to the data acquisition system of the train test bench according to claim 1, wherein the data acquisition method comprises:
acquiring the pressure data of a test truck by the plurality of sensors on each of the acquisition sections and transmitting the pressure data to the corresponding acquisition module;
transmitting the pressure data of the plurality of test trucks to the corresponding controllers by the plurality of acquisition modules;
converting the pressure data of the test trucks in a digital-to-analog method by each of the controllers, and sending the pressure data to the industrial control computer in a form of electrical signals; and
recognizing and converting the electrical signals by the industrial control computer, and presenting the electrical signals in the form of a curve.

15. The data acquisition method according to claim 14, wherein the data acquisition system of the train test bench further comprises a switch, wherein the plurality of controllers is all connected to the switch, and the switch is connected to the industrial control computer; and
the step of converting the pressure data of the test trucks in a digital-to-analog method by each of the controllers, and sending the pressure data to the industrial control computer in a form of electrical signals comprises:
sending the pressure data to the industrial control computer in the form of the electrical signals by the switch after converting the pressure data of the test trucks in the digital-to-analog method by each of the controllers.

16. The data acquisition method according to claim 14, wherein the plurality of acquisition sections is evenly arranged in the plurality of test trucks at intervals.

17. The data acquisition method according to claim 14, wherein in a conventional acquisition mode, the plurality of acquisition sections is evenly arranged in the plurality of test trucks at intervals, and a number of the acquisition sections is smaller than a number of the test trucks.

18. The data acquisition method according to claim 14, wherein each of the test trucks is provided with one of the acquisition sections.

19. The data acquisition method according to claim 18, wherein in an all-type acquisition mode, each of the test trucks is provided with one of the acquisition sections, and the number of the acquisition sections is equal to the number of the test trucks.

20. The data acquisition method according to claim 1, wherein the plurality of test trucks is arranged in a serpentine arrangement, and the plurality of controllers is sequentially arranged in an arrangement path of the plurality of test trucks.
